(19) United States
(12) Patent Application Publication
(10) Pub. No.: US 2009/0259519 A1
(43) Pub. Date: Oct. 15, 2009

(54) Advertisements Targeted to Social Groups that Establish Program Popularity

(75) Inventors: Dennis G. Cronin, Redmond, WA (US); Peter T. Barrett, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/102,860

(22) Filed: Apr. 14, 2008

(51) Int. Cl. G06Q 30/00

(52) U.S. Cl. 705/10; 705/14

(57) ABSTRACT

Advertisements targeted to social groups that establish program popularity is described. In embodiment(s), display durations can be enumerated for each program that is rendered for viewing at media devices associated with each member of a social group. A popularity factor for each of the programs can be established based on enumerated display durations of each of the programs, and popular programs can be determined for the members of the social group based on the popularity factors. Advertisements can then be targeted to the members of the social group based on the popular programs.

### BACKGROUND

Viewers have an ever-increasing selection of media content to choose from, such as television programming, on-demand movies and music, and/or recorded media content that is available for streaming from a content distributor to a media device. For example, scheduled television programming can be recorded at the time of broadcast when initially distributed for viewing, and can then be made available for on-demand viewing when requested via a media device. This is commonly referred to as Network Digital Video Recording (nDVR) and a viewer can request the recorded television content, such as movies and television programs, when convenient for the viewer.

A viewer can request the media content for viewing and/or playback from any number of various media devices, such as wired and/or wireless devices, to include a television client device (e.g., a television set-top box or a digital video recorder (DVR)), a broadcast-enabled computer device, a portable media content player, and the like. Given the ever-increasing selection and variety of media content that is available, as well as the many devices that can be utilized for viewing and/or playback of the media content, users may want to locate media content (e.g., television programming, movie choices, music, etc.) that is of interest to them, as well as organize the available media content and/or locate and receive recommended media content.

In addition, advertisers want to be able to reach consumers on any of the various media devices that are used for viewing and/or playback of the media content. Advertisers want to have advertising messages distributed to consumers as advertisements that are included in television programming, as movie pre-views before a movie, and included with the other types of recorded media content. Ideally, advertisers also want to be able to distribute an advertising message to specific consumers that are more likely to be interested in the product or service that is being offered in an advertisement.

### SUMMARY

This summary is provided to introduce simplified concepts of advertisements targeted to social groups that establish program popularity. The simplified concepts are further described below in the Detailed Description. This summary is not intended to identify essential features of the claimed subject matter, nor is it intended for use in determining the scope of the claimed subject matter.

Advertisements targeted to social groups that establish program popularity is described. In embodiment(s), display durations can be enumerated for each program that is rendered for viewing at media devices associated with each member of a social group. A popularity factor for each of the programs can be established based on enumerated display durations of each of the programs, and popular programs can be determined for the members of the social group based on the popularity factors. Advertisements can then be targeted to the members of the social group based on the popular programs.

In other embodiment(s), the display duration for a program can be enumerated as a sum of minutes that the program is rendered for viewing at a media device. Alternatively or in addition, the display duration for a program can be enumerated as a percentage of a sum of minutes that the program is rendered for viewing compared to a total length of the program in minutes.

In other embodiment(s), a list of the popular programs can be generated for distribution to the media devices that are associated with the members of the social group. Alternatively or in addition, the list of the popular programs can be provided to media content providers and/or to advertisers for marketing analysis. The advertisements that are targeted to the members of the social group can also be received from one or more of the advertisers.

In other embodiment(s), a social group can be formed based on one or more associations of the members of the social group. For example, the members of a social group may be associated based on members that are selected by other members of the social group, based on program choices requested via media devices of the members, based on communications between the members, based on gaming associations of the members, and/or any other basis by which to associate members to form a social group. In an embodiment, the members of a social group can be automatically expanded to include more members to maintain their privacy when the popular programs are determined from a minimum number of the group members.

### BRIEF DESCRIPTION OF THE DRAWINGS

Embodiments of advertisements targeted to social groups that establish program popularity are described with reference to the following drawings. The same numbers are used throughout the drawings to reference like features and components:

FIG. 1 illustrates an example system in which embodiments of advertisements targeted to social groups that establish program popularity can be implemented.

FIG. 2 illustrates another example system in which embodiments of advertisements targeted to social groups that establish program popularity can be implemented.

FIG. 3 illustrates example method(s) for advertisements targeted to social groups that establish program popularity in accordance with one or more embodiments.

FIG. 4 illustrates example method(s) for advertisements targeted to social groups that establish program popularity in accordance with one or more embodiments.

FIG. 5 illustrates various components of an example device which can implement embodiments of advertisements targeted to social groups that establish program popularity.

FIG. 6 illustrates various devices and components in an example media content distribution system in which embodiments of advertisements targeted to social groups that establish program popularity can be implemented.

### DETAILED DESCRIPTION

Embodiments of advertisements targeted to social groups that establish program popularity provide that social groups of associated members can be formed from which popular programs are determined, and the members of a social group can then receive targeted advertisements. A social group (also referred to as a “viewer group” or “circle of friends”) can be formed to include members who are more likely to have an association with each other, and therefore common interests in television programs, movies, and other media content preferences. A member of the social group can then receive a list of popular programs and/or advertisements that are determined from the group, and the member may find television programming, movies, and other media content that is of interest.

When television programs (e.g., to include movies and other types of media content) are requested from media devices, a display duration can be enumerated for each of the programs that are rendered for viewing at the media devices that are associated with each of the members of a social group. In various embodiments, the display duration for a particular program corresponds to the elapsed time during which the program, or only a portion of the program, is displayed for viewing by a member of the social group (e.g., how long a viewer watches a particular program before changing the channel, turning the program off, or other interruptions to program viewing). The display duration for a particular program can be enumerated as a sum of minutes that the program is rendered for viewing at a media device, and/or can be enumerated as a percentage of a sum of minutes that the program is rendered for viewing compared to a total length of the program in minutes.

A popularity factor for each of the programs can be established based on the enumerated display durations of each of the programs that are rendered for viewing at the media devices by members of a social group. Popular programs for the members of the social group can then be determined based on the popularity factor for each of the programs. A popularity factor for a program can be determined based on several factors and/or heuristics that are used to refine the popularity ranking of the program within the social group. For example, such factors and/or heuristics may include the total viewing time of the program by all or a subset of the members of the social group, a viewing time of less than a minute may be disregarded (e.g., as a channel change), or longer viewing times may be disregarded or downgraded if no additional viewer interaction is detected which may indicate that a viewer left the program unattended. The popularity of a program can be based on active viewing over a configurable duration or period of time that assumes a level of interest in the program based on a number of minutes, or percentage thereof, that the program is rendered for viewing by a member of a social group.

In one or more embodiments, a ranked list of the most popular programs within a specific social group can be generated. In addition, a ranked list may be unique to an individual viewer or member within a social group if the social group is defined uniquely for that member. When a ranked list of the popular programs is generated, the list can be distributed to the media devices that are associated with a member or members of the social group, and a user interface can display the list of the popular programs. A user interface can also display an identifier of the social group, a list of the members in the social group, and/or may include a list of targeted advertisements for selection and viewing in addition to the list of the popular programs.

A list of the popular programs can also be provided as feedback to media content providers and creators for marketing analysis and to determine the popularity of respective programs and movies. The list of the popular programs can also be provided as feedback to advertisers for marketing analysis. The advertisers can then target advertisements to the members of the social group from which the popular programs were determined using an established “signature” that represents the social group and the associated list of popular programs to derive targeting rules appropriate for that social group or individual members of the social group. This group-oriented advertisement targeting provides a more meaningful context for targeting the advertisements, rather than simply deriving preference data for the individual viewing habits of an isolated user. The “signature” of the popular programs list allows the media content providers, creators, and the advertisers to target particular groups of individuals with advertisements, previews of upcoming programs, other related programs that may be of interest, and/or any other type of promotional materials.

While features and concepts of the described systems and methods for advertisements targeted to social groups that establish program popularity can be implemented in any number of different environments, systems, and/or various configurations, embodiments of advertisements targeted to social groups that establish program popularity are described in the context of the following example systems and environments.

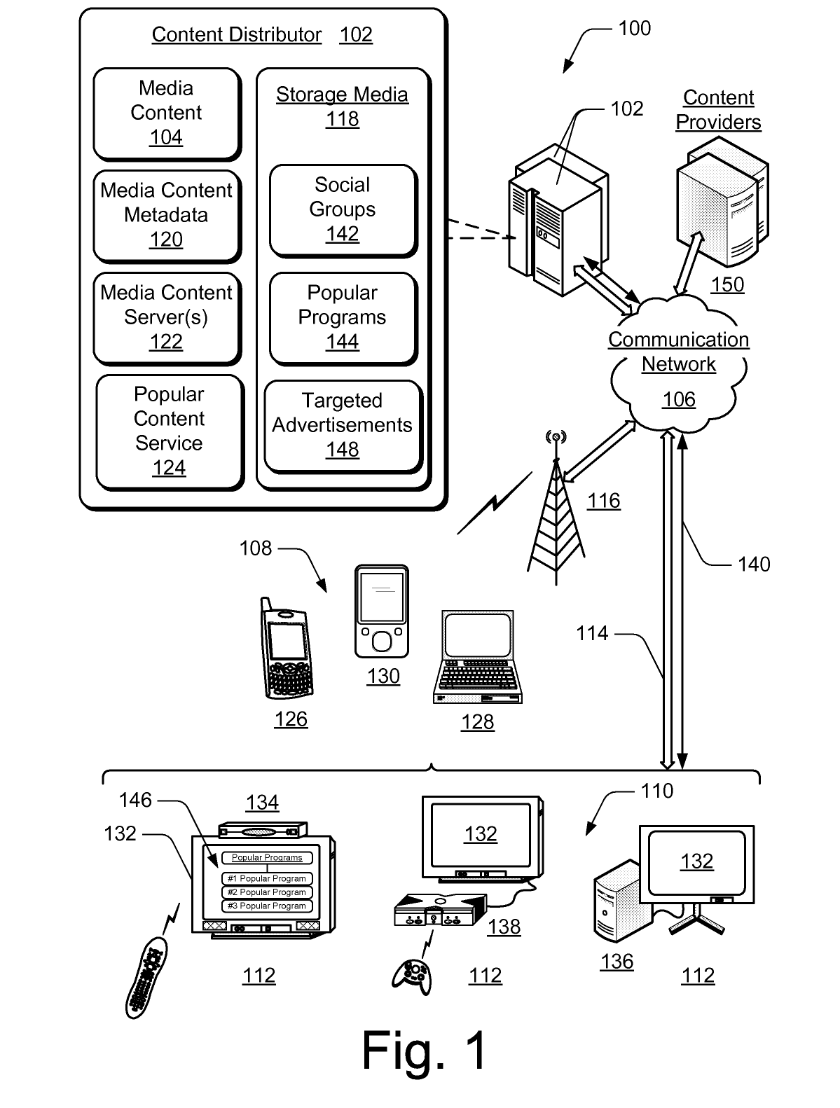

FIG. 1 illustrates an example system 100 in which various embodiments of advertisements targeted to social groups that establish program popularity can be implemented. In this example, system 100 includes one or more content distributors 102 that communicate or otherwise provide media content 104 to any number of various media devices via a communication network 106. The various media devices can include wireless media devices 108 as well as other client devices 110 (e.g., wired and/or wireless devices) that are implemented as components in various client systems 112 in a media content distribution system.

The communication network 106 can be implemented to include a broadcast network, an IP-based network 114, and/or a wireless network 116 that facilitates media content distribution and data communication between the content distributors 102 and any number of the various media devices. The communication network 106 can also be implemented as part of a media content distribution system using any type of network topology and/or communication protocol, and can be represented or otherwise implemented as a combination of two or more networks.

In the example system 100, a content distributor 102 includes storage media 118 to store or otherwise maintain various data and media content, such as media content 104, media content metadata 120, and/or recorded on-demand assets. In a Network Digital Video Recording (nDVR) implementation, recorded on-demand assets can be recorded when initially distributed to the various media devices as scheduled television media content. The storage media 118 can be implemented as any type of memory, random access memory (RAM), a nonvolatile memory such as flash memory, read only memory (ROM), and/or other suitable electronic data storage. Content distributor 102 can also include one or more media content servers 122 that are implemented to communicate, or otherwise distribute, the media content 104, media content metadata 120, recorded on-demand assets, and/or other data to any number of the various media devices.

The media content 104 and/or recorded on-demand assets (e.g., recorded media content) can include any type of audio, video, and/or image media content received from any type of media content source. As described throughout, “media content” can include television programs (or programming), advertisements, commercials, music, movies, and on-demand media content. Other media content can include interactive games, network-based applications, and any other audio, video, and/or image content (e.g., to include program guide application data, user interface data, search results and/or recommendations, and the like).

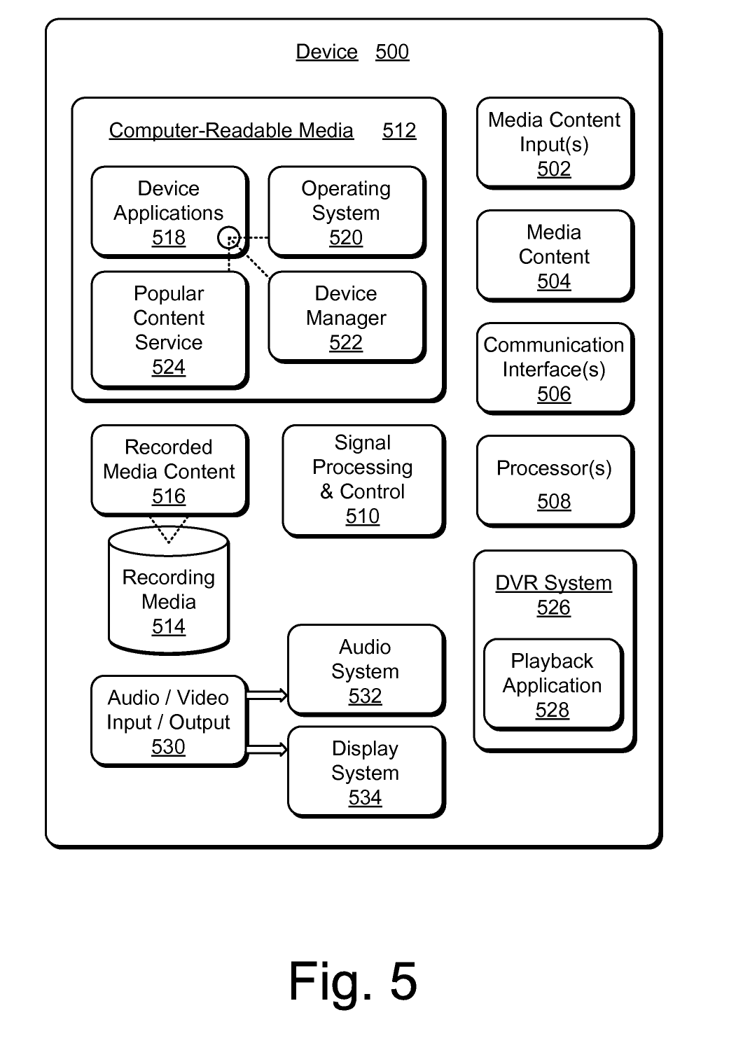

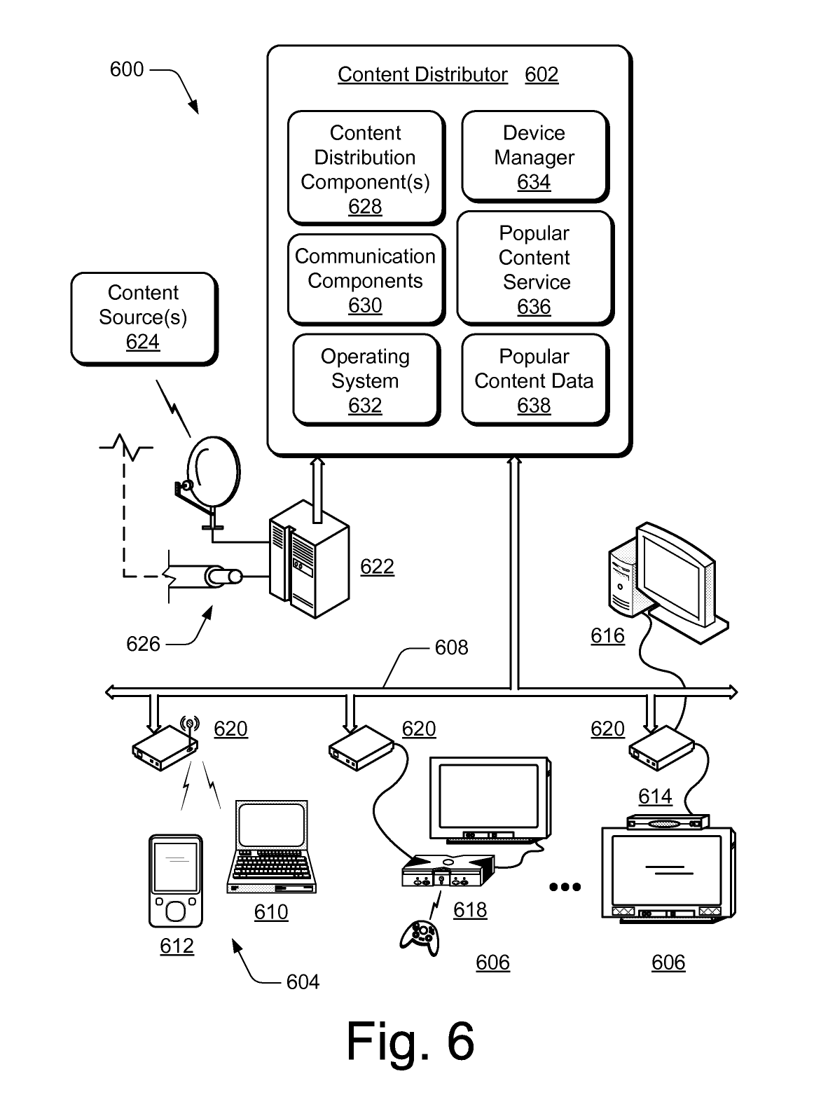

Content distributor 102 also includes a popular content service 124 that can be implemented as computer-executable instructions and executed by processor(s) to implement the various embodiments and/or features described herein. In addition, a content distributor 102 can be implemented with any number and combination of differing components as further described with reference to the example device shown in FIG. 5 and/or the example content distributor shown in FIG. 6. The popular content service 124, as well as other functionality described to implement embodiments of advertisements targeted to social groups that establish program popularity, can also be provided as a service apart from the content distributor 102 (e.g., on a separate server or by a third party service).

The wireless media devices 108 can include any type of device implemented to receive and/or communicate wireless data, such as any one or combination of a mobile phone device 126 (e.g., cellular, VoIP, WiFi, etc.), a portable computer device 128, a media device 130 (e.g., a personal media player, portable media player, etc.), and/or any other wireless media device that can receive media content in any form of audio, video, and/or image data. Each of the client systems 112 include a respective client device and display device 132 that together render or playback any form of audio, video, and/or image media content.

A display device 132 can be implemented as any type of a television, high definition television (HDTV), LCD, or similar display system. A client device in a client system 112 can be implemented as any one or combination of a television client device 134 (e.g., a television set-top box, a digital video recorder (DVR), etc.), a computer device 136, a gaming system 138, an appliance device, an electronic device, and/or as any other type of client device that may be implemented to receive media content in any form of audio, video, and/or image data in a media content distribution system.

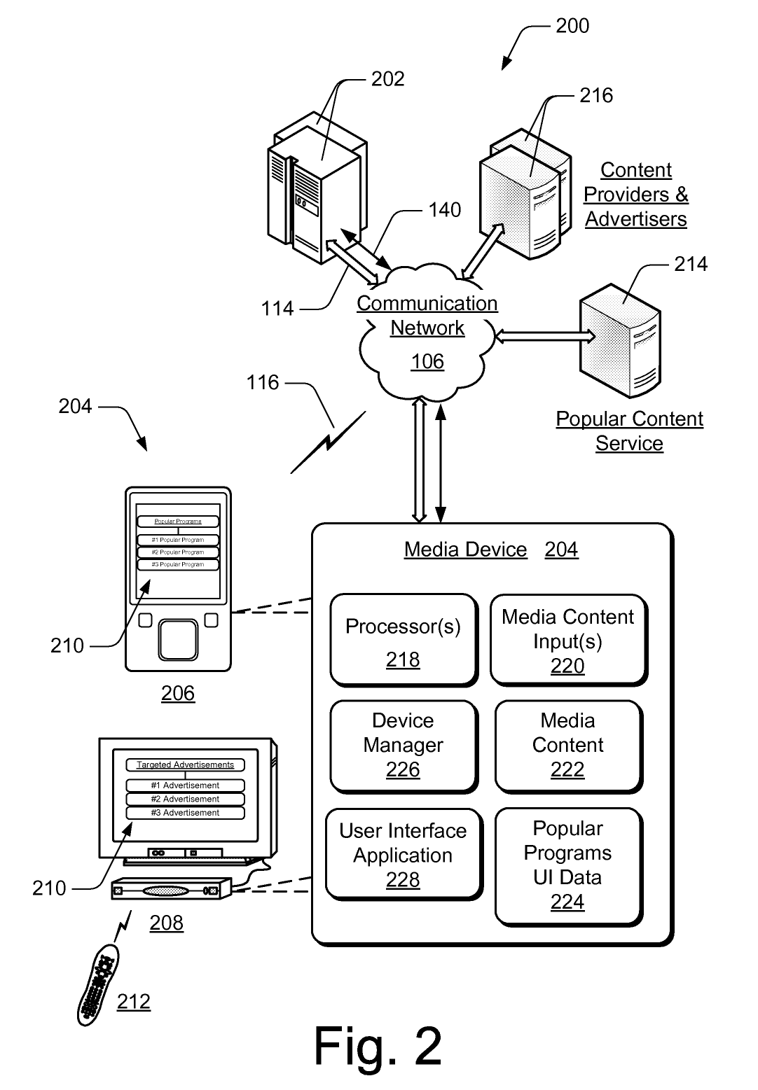

Any of the media devices can be implemented with one or more processors, communication components, memory components, signal processing and control circuits, and a media content rendering system. Further, any of the wireless media devices 108 and/or other client devices 110 can be implemented with any number and combination of differing components as further described with reference to the example media device shown in FIG. 2 and/or the example device shown in FIG. 5. A media device may also be associated with a user or viewer (i.e., a person) and/or an entity that operates the device such that a media device describes logical devices that include users, software, and/or a combination of devices.

Any of the wireless media devices 108 and/or other client devices 110 can communicate with any number of content distributors 102 via a two-way data communication link 140 of the communication network 106. It is contemplated that any one or more of the arrowed communication link 140, IP-based network 114, and wireless network 116, along with communication network 106, facilitate two-way data communication, such as from a media device to a content distributor 102 and vice-versa.

The popular content service 124 at content distributor 102 can be implemented to form social groups 142 that each include members who are determined by the popular content service 124 to be associated. Social groups (e.g., also referred to as “viewer groups”) can include members who are more likely to have an association with each other, and therefore common interests and media content preferences. In an embodiment, the popular content service 124 can determine member associations to form a social group based on program and/or other media content choices requested by the members of the social group; based on communication data links between the members, such as on-line communications for email messages, text messages, instant messages, pages, etc.; and/or based on gaming associations or sessions of the members, such as from user account information and the like.

Alternatively or in addition, a social group 142 can be defined by one or more of the members of the social group. For example, a member (or members) of a social group 142 can define who is a member of the group by permitting another user to join as a member. The members of a social group 142 may be associated from a “friends list” or “buddy list”, such as commonly used in instant messaging environments. The members of a social group may also be associated as any one or more of a work group, music group, family group, church group, etc. as the members that form the social group. Additionally, a group of friends or acquaintances that are associated to form a social group can be “internal” to a media content distribution system (e.g., users and/or viewers having associated user accounts in example system 100), or may be imported from an external environment, such as from an instant messaging community, a gaming community, and the like.

In an embodiment, the members of a social group 142 can be expanded to include one or more subsequent tiers of friends, buddies, acquaintances, or associations of the current members. An arbitrary number of links or tiers of friends can be used to transiently define a social group that provides for a larger group from which the popular programs 144 are determined. In another embodiment, the popular content service 124 can apply rules to automatically expand a social group to include additional members to maintain privacy of the members when the popular programs are determined from a minimum number of the group members. If a group of friends that are the members of a social group is too small, a member may be able to determine specifically what another member of the social group is viewing, thus creating a privacy concern. In an implementation, the popular content service 124 can detect a configurable lower bounds of acceptable viewer input and either expand the number of members of the group, (e.g., by traversing one or more levels of links to friends of friends, and then to additional levels of friends as applicable), or substitute some generic large audience aggregation of popular shows, such as from a ratings service for example.

The media content 104 is referred to as “programs” or “television programs” in this example. When the media content 104 is requested from any of the various media devices, the popular content service 124 can enumerate a display duration for the programs that are rendered for viewing at the media devices that are associated with members of a social group 142. The popular content service 124 can enumerate the display duration for those programs that are “recently” rendered for viewing, where “recently” rendered programs may be within a specified number of days, within a one-week duration, within a month duration, and/or within any other, optionally configurable, period of time or days over which the display durations for the various programs are enumerated.

In an embodiment, the popular content service 124 can enumerate the display duration for a particular program as a sum of minutes that the program is rendered for viewing at a media device that is associated with a member of the social group. In another embodiment, the popular content service 124 can enumerate the display duration for a program as a percentage of a sum of minutes that the program is rendered for viewing compared to a total length of the program in minutes. For example, a sixty-minute (60 min) program that is rendered for viewing at a media device for forty-five minutes (45 min) would be enumerated as seventy-five percent (75%) viewed. In various embodiments, the calculated percentage can be adjusted or weighted by incorporating information about skipping segments of content, and/or information about viewer interaction with a program that is displayed for viewing to determine whether the viewer was actively watching the program, or just left the playback session unattended.

The popular content service 124 can then establish a popularity factor for each of the programs based on the enumerated display durations of the programs that are rendered for viewing at the media devices. The popular content service 124 can then determine popular programs 144 for the members of the social group 142 based on the popularity factor for each of the programs. In an embodiment, the popular programs 144 are those requested and viewed the most, those viewed for a longer duration, and/or for a greater percentage of viewing time (e.g., the programs that are rendered for viewing at the respective media devices of the members of the social group).

The popular content service 124 can generate a list of the popular programs for distribution to the media devices that are associated with the members of the social group. For example, the popular content service 124 can provide, distribute, or otherwise communicate the list of popular programs 144 to a media device (e.g., television client device 134) for a user interface 146 that displays as a list of the popular programs. In an embodiment, a list of popular programs can be created or otherwise generated for each member of a social group individually, and can be based on the popular programs determined for the other members of the social group. An individual member can then determine which programs the other members of the social group consider popular. In one or more embodiments, the user interface 146 can also display an identifier of the social group, a list of the members in the social group, and/or may include a list of targeted advertisements 148 for selection and viewing in addition to the list of popular programs.

In an embodiment, the popular content service 124 can provide a list of the popular programs 144 as feedback to media content providers 150, television show and movie creators, producers, and the like for marketing analysis and to determine the popularity of respective programs and movies. Alternatively or in addition, the popular content service 124 can provide the list of the popular programs 144 as feedback to one or more advertisers (e.g., also generally the content providers at 150) for marketing analysis, and/or then receive targeted advertisements 148 from the advertisers. The targeted advertisements 148 can be determined by an advertiser and/or by a content distributor 102 for the members of a social group based on a list of the popular programs 144, or by combining a list of popular programs with information about individual viewing habits and applying weightings and heuristics to further refine the targeting rules.

The feedback of the popular programs can allow the creators and advertisers to target particular groups of individuals with advertisements, previews of upcoming programs, other related programs that may be of interest to the members of a social group, and/or any other type of promotional materials. In addition to targeting advertisements to the members of a social group via television programming, such as through television client device 134, an advertiser or media content provider 150 can provide a user with an advertisement or promotional information via a Web-based communication at computer device 136, or via any other type of media device associated with a particular user.

The storage media 118 at content distributor 102 can be utilized to maintain or otherwise store identifiers of the members of the various social groups 142. In addition, the storage media 118 can be utilized to maintain identifiers of the popular programs 144 and/or the targeted advertisements 148. The popular content service 124 and/or the content distributor 102 can also be implemented to associate the various members of a social group 142 and corresponding targeted advertisements 148 with respective users, media devices, and/or combinations thereof.

Although illustrated as described as a component or module of the content distributor 102, the popular content service 124 can be implemented as an independent service to implement embodiments of advertisements targeted to social groups that establish program popularity. Further, although the popular content service 124 is illustrated and described as a single component or module, the popular content service 124 can be implemented as several component applications or modules distributed to implement various embodiments of advertisements targeted to social groups that establish program popularity as described herein.

FIG. 2 illustrates an example system 200 in which various embodiments of advertisements targeted to social groups that establish program popularity can be implemented. In this example, system 200 includes one or more content distributors 202 and examples of wired and/or wireless media devices 204, such as a portable media device 206 and a television client device 208. A media device 204 can display various types of media content, as well as a user interface 210 that displays as a list of the popular programs. A viewer can interact with a media device 204 and initiate viewer navigation inputs and selections of media content from the user interface 210 with user inputs, such as on the portable media device 206 or with a remote control input device 212. For example, a popular program can be selected with remote control inputs and the list of the popular programs can be scrolled up and/or down to display and select the various popular programs. In addition, the user interface 210 can also include an identifier of a social group, a list of the members in the social group, and/or may include a list of the targeted advertisements for selection and viewing in addition to the list of the popular programs.

An example of a content distributor is described with reference to content distributor 102 shown in FIG. 1. However, in this example system 200, a popular content service 214 is independent and implemented apart from content distributor 202 (e.g., on a separate server or by a third party service). The popular content service 214 can be implemented as an optional service and/or as a service that users pay for to receive media content recommendations and/or a list of popular programs displayed as user interface 210.

The example system 200 also includes content providers and advertisers 216 that can receive a list of the popular programs as feedback for marketing analysis from the content distributors 202 and/or from the popular content service 214. The content distributor 202, media devices 204, popular content service 214, and the content providers and advertisers 216 can all be implemented for communication with each other via the communication network 106, the IP-based network 114, and/or the wireless network 116.

In the example system 200, a media device 204 includes one or more processors 218 (e.g., any of microprocessors, controllers, and the like), media content inputs 220, and media content 222 (e.g., received media content, media content that is being received, recommended media content, recorded media content, etc.). The media content 222 can also include popular programs and targeted advertisements. The media content inputs 220 can include any type of wireless, broadcast, and/or over-the-air inputs via which media content is received. In addition, media device 204 can receive user interface data 224 for popular programs from a content distributor 202 and/or from the popular content service 214 via the media content inputs 220.

Media device 204 can also include a device manager 226 (e.g., a control application, software application, signal processing and control module, etc.) that can be implemented as computer-executable instructions and executed by the processors 218 to implement various embodiments and/or features of advertisements targeted to social groups that establish program popularity. The device manager 226 can be implemented to monitor and/or receive selectable inputs (e.g., viewer selections, navigation inputs, etc.) via the input device 212, and initiate communication of user selections back to a content distributor 202 and/or to the popular content service 214.

Media device 204 can also include a user interface application 228 that can be implemented as computer-executable instructions and executed by the processors 218 to implement various embodiments and/or features of advertisements targeted to social groups that establish program popularity. The user interface application 228 can process the user interface data 224 for the popular programs from which the user interface 210 can be rendered and/or displayed for viewing at a media device 204.

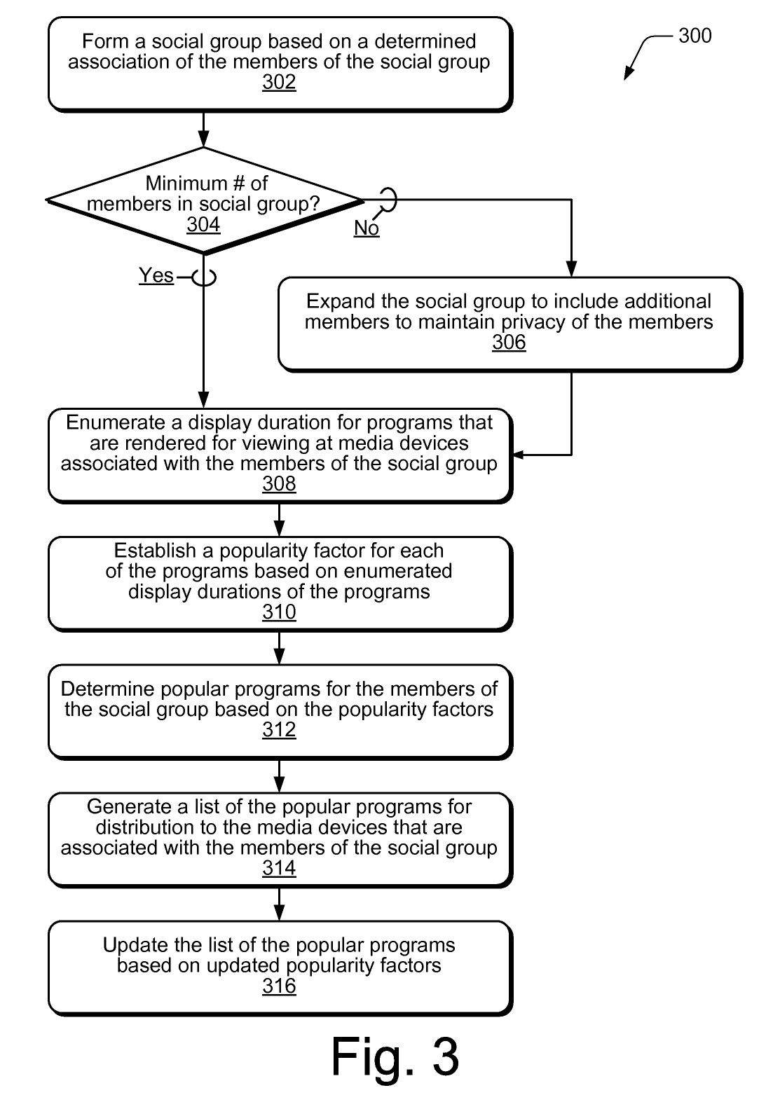

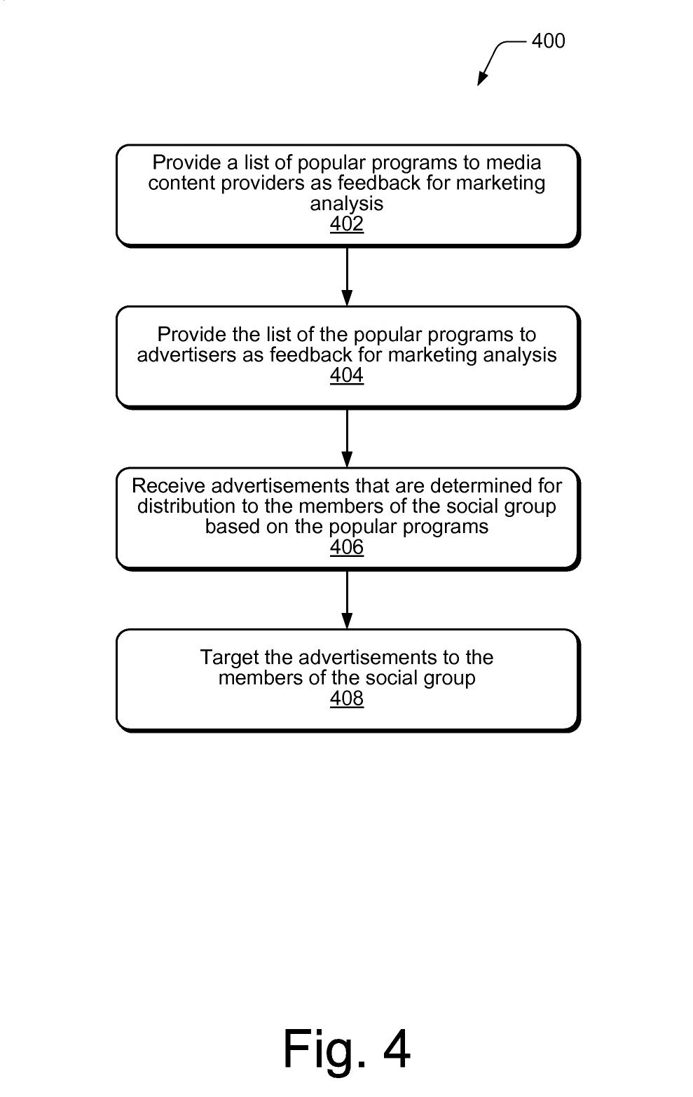

Example methods 300 and 400 are described with reference to respective FIGS. 3 and 4 in accordance with one or more embodiments of advertisements targeted to social groups that establish program popularity. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of advertisements targeted to social groups that establish program popularity. The order in which the method is described is not intended to be construed as a limitation, and any number of the described method blocks can be combined in any order to implement the method, or an alternate method.

At block 302, a social group is formed based on a determined association of the members of the social group. For example, the popular content service 124 at content distributor 102 (FIG. 1) forms social groups that include members who are determined by the popular content service to be associated. The popular content service 124 determines member associations to form a social group based on program choices requested by the members of the social group via respective media devices, based on communications between the members, and/or based on gaming associations of the members. The popular content service 124 can also facilitate associating the members of a social group when selected by one or more of the members themselves.

At block 304, a determination is made as to whether a minimum number of members are included in the social group. For example, the popular content service 124 detects whether to expand a social group 142 to include additional members to maintain privacy of the members when the popular programs 144 are determined from a minimum number of the group members. If there is not a minimum number of members included in the social group (i.e., “no” from block 304), then at block 306, the social group is expanded to include additional members to maintain privacy of the current members when the popular programs are determined. For example, the popular content service 124 can expand the number of members in a social group by including one or more subsequent tiers of friends, buddies, acquaintances, or associations of the current members.

If there is a minimum number of members included in the social group (i.e., “yes” from block 304), or after the social group is expanded to include additional members (at block 306), then at block 308, a display duration is enumerated for each program that is rendered for viewing at media devices associated with each of the members of the social group. For example, the popular content service 124 enumerates the display duration for a program as a sum of minutes that the program is rendered for viewing at a media device that is associated with a member of the social group. Alternatively, the popular content service 124 enumerates the display duration for a program as a percentage of a sum of minutes that the program is rendered for viewing compared to a total length of the program in minutes. Further, the popular content service 124 can include additional information associated with viewer interactions while viewing the program.

At block 310, a popularity factor is established for each of the programs based on enumerated display durations of the programs. For example, the popular content service 124 establishes a popularity factor for each of the programs based on the enumerated display durations of the programs that are rendered for viewing at the media devices. At block 312, popular programs are determined for the members of the social group based on the popularity factors. For example, the popular content service 124 determines popular programs 144 for the members of the social group 142 based on the popularity factor for each of the programs, and as a result in one embodiment, determines a ranked list of popular programs.

At block 314, a list of the popular programs is generated for distribution to the media devices that are associated with the members of the social group. For example, the popular content service 124 generates a list of the popular programs 144 that is provided, communicated, or otherwise distributed to the media devices that are associated with the members of a social group 142. The list of the popular programs 144 can be a single shared list of popular programs, or multiple individual viewer lists. The list(s) of the popular programs 144 can be displayed as a user interface 146 that includes the list of the popular programs, any of which can be selected by a viewer.

At block 316, the list of the popular programs is updated based on updated popularity factors when the popular programs are rendered for viewing at the media devices. For example, the popular content service 124 continues to enumerate a display duration for the popular programs that are rendered for viewing at the media devices associated with the members of the social group (generally at block 308); update the popularity factor for each of the popular programs based on enumerated display durations of the popular programs (generally at block 310); and update the popular programs for the members of the social group based on the updated popularity factors (generally at block 312).

FIG. 4 illustrates example method(s) 400 of advertisements targeted to social groups that establish program popularity. The order in which the method is described is not intended to be construed as a limitation, and any number of the described method blocks can be combined in any order to implement the method, or an alternate method.

At block 402, a list of popular programs is provided to media content providers as feedback for marketing analysis. For example, the popular content service 124 at content distributor 102 (FIG. 1) provides a list of the popular programs 144 as feedback to media content providers 150 for marketing analysis and to determine the popularity of respective programs and movies. At block 404, the list of the popular programs is provided to advertisers as feedback for marketing analysis. For example, the popular content service 124 also provides the list of the popular programs 144 as feedback to one or more advertisers for marketing analysis.

At block 406, advertisements are received that are determined for distribution to the members of the social group based on the popular programs. For example, the content distributor 102 receives targeted advertisements 148 from one or more advertisers. At block 408, the advertisements are targeted to the members of the social group. The targeted advertisements 148 can be determined by an advertiser and/or by a content distributor 102 for distribution to a member, or to a subset of the members, of a social group based on the popular programs 144. The popular content service 124 initiates advertisements that are targeted to the members of the social group.

FIG. 5 illustrates various components of an example device 500 that can be implemented as any form of a computing, electronic, appliance, and/or media device to implement various embodiments of advertisements targeted to social groups that establish program popularity. For example, device 500 can be implemented as a content distributor, a popular content service, and/or a media device as shown in FIG. 1 and/or FIG. 2. In various embodiments, device 500 can be implemented as any one or combination of a wired and/or wireless media device, a mobile phone device, a portable computer device, a television client device (e.g., a television set-top box, a digital video recorder (DVR), etc.), a computer device, a gaming system, an appliance device, an electronic device, and/or as any other type of media that may be implemented to receive media content in any form of audio, video, and/or image data.

Device 500 can include one or more media content inputs 502 via which any type of audio, video, and/or image media content 504 can be received from a media content source. The media content inputs 502 can include Internet Protocol (IP) inputs over which streams of media content are received via an IP-based network. Device 500 further includes one or more communication interfaces 506 that can be implemented as any one or more of a serial and/or parallel interface, a wireless interface, any type of network interface, a modem, and as any other type of communication interface. The communication interfaces 506 provide a connection and/or communication links between device 500 and a communication network by which other electronic, computing, and communication devices can communicate data with device 500.

Device 500 can include one or more processors 508 (e.g., any of microprocessors, controllers, and the like) which process various computer-executable instructions to control the operation of device 500, to communicate with other electronic and computing devices, and to implement embodiments of advertisements targeted to social groups that establish program popularity. Alternatively or in addition, device 500 can be implemented with any one or combination of hardware, firmware, or fixed logic circuitry that is implemented in connection with signal processing and control circuits which are generally identified at 510.

Device 500 can also include computer-readable media 512, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 500 may also include a recording media 514 to maintain recorded media content 516 (e.g., recorded on-demand media content, or assets) that device 500 receives and/or records.

Computer-readable media 512 provides data storage mechanisms to store media content 504, as well as various device applications 518 and any other types of information and/or data related to operational aspects of device 500. For example, an operating system 520 can be maintained as a computer application with the computer-readable media 512 and executed on the processors 508. The device applications 518 can also include a device manager 522 when device 500 is implemented as a media device and/or as a content distributor, and can include a popular content service 524 when device 500 is implemented as a content distributor. In this example, the device applications 518 are shown as software modules and/or computer applications that can implement various embodiments of advertisements targeted to social groups that establish program popularity.

When implemented as a television client device, the device 500 can also include a DVR system 526 with a playback application 528 that can be implemented as a media control application to control the playback of recorded media content 516 and/or any other audio, video, and/or image media content 504 that can be rendered and/or displayed for viewing. The recording media 514 can maintain recorded media content that may include the media content 504 when it is received from a content distributor and recorded. For example, the media content 504 can be recorded when received as a viewer-scheduled recording, or when the recording media 514 is implemented as a pause buffer that records the media content 504 as it is being received and rendered for viewing.

Device 500 can also include an audio and/or video input/output system 530 that provides audio data to an audio rendering system 532 and/or provides video data to a display system 534. The audio rendering system 532 and/or the display system 534 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, audio rendering system 532 and/or the display system 534 can be implemented as external components to device 500. Alternatively, the audio rendering system 532 and/or the display system 534 can be implemented as integrated components of the example device 500.

Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

FIG. 6 illustrates an example media content distribution system 600 in which various embodiments of advertisements targeted to social groups that establish program popularity can be implemented. System 600 facilitates the distribution of media content, content metadata, and/or other associated data to multiple viewers, users, viewing systems, and devices. System 600 includes a content distributor 602 and any number of wired and/or wireless media devices. The media devices can include wireless media devices 604 as well as other client devices that are implemented as components in various client systems 606, each configured for data communication via a communication network 608. Each of the media devices and other client devices can receive media content, program content, program guide data, advertising content, closed captions data, content metadata, and the like from content server(s) of the content distributor 602 via the communication network 608.

The wireless media devices 604 can include any type of device implemented to receive and/or communicate wireless data, such as a portable computer device 610, a media device 612 (e.g., a personal media player, portable media player, etc.), and/or any other wireless media device that can receive content in any form of audio, video, and/or image media content. Each of the client systems 606 can include a respective client device and display device that together render media content in any form of audio, video, and/or image data. A client device in a client system 606 can be implemented as any one or combination of a television client device 614 (e.g., a television set-top box, a digital video recorder (DVR), etc.), a computer device 616, a gaming system 618, an appliance device, an electronic device, and/or as any other type of client device that may be implemented to receive any form of audio, video, and/or image media content.

The communication network 608 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 608 can be implemented using any type of network topology and any network communication protocol, and can be represented or otherwise implemented as a combination of two or more networks. A digital network can include various hardwired and/or wireless links 620, such as routers, gateways, and so on to facilitate communication between content distributor 602 and the various media devices.

System 600 includes a media server 622 that receives content from various content sources 624, such as media content from a content provider, program guide data from a program guide source, and advertising content from an advertisement provider. The media server 622 can represent an acquisition server that receives audio, video, and/or image media content from a content provider; an EPG server that receives program guide data from a program guide source; and/or an advertising management server that receives advertising content from an advertisement provider.

The content sources 624 control distribution of the media content, the program guide data, and the advertising content to the media server 622 and/or to other servers of system 600. The media content, program guide data, and advertising content can be distributed via various transmission media 626, such as satellite transmission, radio frequency transmission, cable transmission, and/or via any number of other wired or wireless transmission media. In this example, media server 622 is shown as an independent component of system 600 that communicates the media content, program guide data, and advertising content to content distributor 602. In an alternate implementation, media server 622 can be implemented as a component of content distributor 602.

Content distributor 602 is representative of a headend service in a content distribution system, for example, that provides the media content, program guide data, advertising content, and content metadata to multiple subscribers (e.g., the various media devices and client systems 606). The content distributor 602 can be implemented as a satellite operator, a network television operator, a cable operator, and the like to control distribution of media content, program and advertising content, and any other audio, video, and/or image content to the media devices and client systems 606.

Content distributor 602 includes various content distribution components 628 to facilitate media content processing and distribution, such as a subscriber manager, a device monitor, and one or more content servers. The subscriber manager manages subscriber data, and the device monitor maintains client state information and monitors the media devices, client devices, and/or the client systems. Although the various managers, servers, and monitors of content distributor 602 (to include the media server 622 in one embodiment) are described as distributed, independent components, any one or more of the managers, servers, and monitors can be implemented together as a multi-functional component of content distributor 602. Additionally, any one or more of the managers, servers, and monitors described with reference to system 600 can implement features and embodiments of advertisements targeted to social groups that establish program popularity.

The content distributor 602 can also include communication components 630 that are implemented to facilitate media content distribution to the various media devices and other client devices via the communication network 608. The content distributor 602 can also include one or more processors to process various computer-executable instructions, such as an operating system 632, a device manager 634, and a popular content service 636. The content distributor 602 can also include computer-readable media for data storage to maintain popular content data 638 (e.g., popular programs and/or targeted advertisements) for embodiments of advertisements targeted to social groups that establish program popularity.

Although embodiments of advertisements targeted to social groups that establish program popularity have been described in language specific to features and/or methods, it is to be understood that the subject of the appended claims is not necessarily limited to the specific features or methods described. Rather, the specific features and methods are disclosed as example implementations of advertisements targeted to social groups that establish program popularity.

1. A method, comprising:
enumerating a display duration for each program that is rendered for viewing at media devices associated with each member of a social group;
establishing a popularity factor for each of the programs based on enumerated display durations of each of the programs;
determining popular programs for the members of the social group based on the popularity factors that are established when the programs are rendered for viewing; and
targeting advertisements to the members of the social group based on the popular programs.

2. A method as recited in claim 1, further comprising generating a list of the popular programs for distribution to the media devices that are associated with the members of the social group.

3. A method as recited in claim 1, further comprising providing a list of the popular programs as feedback to one or more media content providers for marketing analysis.

4. A method as recited in claim 1, further comprising providing a list of the popular programs as feedback to one or more advertisers for marketing analysis.

5. A method as recited in claim 1, wherein the display duration for a program is enumerated as a sum of minutes that the program is rendered for viewing at a media device.

6. A method as recited in claim 1, wherein the display duration for a program is enumerated as a percentage of a sum of minutes that the program is rendered for viewing compared to a total length of the program in minutes.

7. A method as recited in claim 1, further comprising associating the members of the social group when selected by one or more of the members.

8. A method as recited in claim 1, further comprising associating the members of the social group based on program choices requested via the media devices by the members.

9. A method as recited in claim 1, further comprising associating the members of the social group based on communications between the members.

10. A method as recited in claim 1, further comprising associating the members of the social group based on gaming associations of the members.

11. A method as recited in claim 1, further comprising expanding the social group to include additional members when the popular programs are determined from a minimum number of the members of the social group, said expanding the social group to include the additional members to maintain privacy of the members.

12. A method as recited in claim 1, further comprising updating a list of the popular programs based on updated popularity factors when the popular programs are rendered for viewing at the media devices.

13. A content distributor, comprising:
a popular content service configured to:
enumerate a display duration for each program that is rendered for viewing at media devices associated with each member of a social group;
determine popular programs for the members of the social group based on a popularity factor for each of the programs, a popularity factor being established based on enumerated display durations of each of the programs that are rendered for viewing; and
a storage media configured to maintain a list of the members of the social group, a list of the popular programs, and targeted advertisements that are determined based on the popular programs.

14. A content distributor as recited in claim 13, wherein the popular content service is further configured to determine the targeted advertisements for the members of the social group based on the popular programs.

15. A content distributor as recited in claim 13, wherein the popular content service is further configured to provide the list of the popular programs as feedback to an advertisement content provider for marketing analysis, and receive the targeted advertisements from the advertisement content provider.

16. A content distributor as recited in claim 13, wherein the popular content service is further configured to enumerate the display duration for a program as a sum of minutes that the program is rendered for viewing at a media device that is associated with a member of the social group.

17. A content distributor as recited in claim 13, wherein the popular content service is further configured to enumerate the display duration for a program as a percentage of a sum of minutes that the program is rendered for viewing compared to a total length of the program in minutes.

18. A content distributor as recited in claim 13, wherein the popular content service is further configured to form the social group based on a determined association of the members.

19. One or more computer-readable media comprising computer-executable instructions that, when executed, direct a popular content service to:
enumerate a display duration for each program that is rendered for viewing at media devices associated with each member of a social group;
establish a popularity factor for each of the programs based on enumerated display durations of each of the programs;
determine popular programs for the members of the social group based on the popularity factors that are established when the programs are rendered for viewing; and
target advertisements to the members of the social group based on the popular programs.

20. One or more computer-readable media as recited in claim 19, further comprising computer-executable instructions that, when executed, direct the popular content service to provide a list of the popular programs as feedback to an advertisement content provider for marketing analysis to determine the advertisements used to target the members of the social group.
